(19) United States
(12) Patent Application Publication
(10) Pub. No.: US 2016/0078371 A1
(43) Pub. Date: Mar. 17, 2016

(54) Computer-Implemented Meetings Distribution System and Method

(71) Applicant: KLIO Travel Ventures, LLC, Marblehead, MA (US)

(72) Inventor: Hervé SEDKY, Marblehead, MA (US)

(73) Assignee: KLIO TRAVEL VENTURES, LLC, Marblehead, MA (US)

(21) Appl. No.: 14/852,117

(22) Filed: Sep. 11, 2015

Related U.S. Application Data
(60) Provisional application No. 62/048,982, filed on Sep. 11, 2014.
(60) Provisional application No. 62/048,979, filed on Sep. 11, 2014.

(51) Int. Cl. G06Q 10/02; G06Q 50/14

(52) U.S. Cl. CPC G06Q 10/02; G06Q 50/14

(57) ABSTRACT

Systems and methods for providing a meeting distribution system are provided. A venue can provide a listing of available space. A system user can search the available space in real time. The system user can be matched with a venue suited to the system user's needs.

### RELATED APPLICATIONS

This application relates to and claims priority under 35 U.S.C. §119(e) to U.S. Provisional Patent Application No. 62/048,979, titled “COMPUTER-IMPLEMENTED SYSTEM AND METHOD FOR MEETINGS DISTRIBUTION SYSTEM AND METHOD,” which was filed on Sep. 11, 2014 and is hereby incorporated by reference herein in its entirety, and to U.S. Provisional Patent Application No. 62/048,982, titled “A COMPUTER-IMPLEMENTED SYSTEM AND METHOD FOR REVIEWING AND RATING CORPORATE TRAVEL AND MEETING SITES,” which was filed on Sep. 11, 2014 and is hereby incorporated by reference herein in its entirety.

### TECHNICAL FIELD

The field of the invention is generally enterprise software, and more specifically meeting distribution software for matching venues with customers.

### BACKGROUND

The market for providing services and accommodations to corporate customers is crowded with suppliers. In particular, businesses today face difficult challenges when selecting service providers across many industries, including travel accommodations and special event venues. In the field of corporate travel, coordinated systems exists to allow a system user to check reviews for suppliers in a consistent and high quality environment. Accordingly, there is a need for a single source system and method for handling meeting and event services, and travel services to enable system users to avail themselves of live inventory from suppliers and then purchase their needs from that inventory in an easy and efficient manner.

### SUMMARY OF THE INVENTION

The present invention is directed to systems and methods for providing a meeting distribution system so that corporations and users may efficiently be matched with venue and event services providers.

In some embodiments, a method for managing venues includes receiving, from a profile collection component, a profile of meeting preferences from a user, comparing the profile with a vector map of available venues, matching the user with an available venue based on the profile and the vector map, and sending a notification of the match to the user.

These and other capabilities of the disclosed subject matter will be more fully understood after a review of the following figures, detailed description, and claims. It is to be understood that the phraseology and terminology employed herein are for the purpose of description and should not be regarded as limiting.

### BRIEF DESCRIPTION OF FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1 shows a system diagram of a meeting distribution system in accordance with some embodiments.

FIG. 2 shows an expanded system diagram of the components of the meeting distribution system in accordance with some embodiments.

FIG. 3 shows a flowchart for a method of providing a meeting distribution system in accordance with some embodiments.

FIG. 4 shows a flowchart for a method of providing price negotiation in a meeting distribution system in accordance with some embodiments of the present invention.

### DETAILED DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the embodiments described below are only examples, and that it is contemplated that there are other systems and methods that are within the scope of the disclosed subject matter.

Embodiments of the disclosure are directed to a Meetings Distribution System (“MDS”). The meeting distribution system can function as a computer-based content aggregation site that allows users to shop and identify venues for meetings, compare the amenities and costs of venues, and contract for guest rooms, meeting space, food and beverage (“F&B”), and audio visual equipment (“A/V”), and process payment to a venue. The system also has a transactional database to capture historical data and provide a variety of administrative modules, as well as reporting and benchmarking capabilities.

According to some embodiments, the MDS, unlike traditional meeting systems, does not require the issuance of a request for proposal (“RFP”), but rather identifies real-time availability of guest rooms, meeting space, and F&B and A/V bundles. F&B and A/V bundles along with other items or services related to a venue may also be considered “associated services.” The system also includes the use of a “click-through” contract and online payment to complete bookings. To facilitate this touchless process, hoteliers may link information relating to their guest rooms, meeting spaces, and catering systems at the property level, and apply yield management methodologies to the combined systems. These hoteliers also may allow this information to be viewed publicly or on a subscription basis. Thus, the MDS system provides a means to simplify and streamline the process for matching users with meeting spaces and associated amenities.

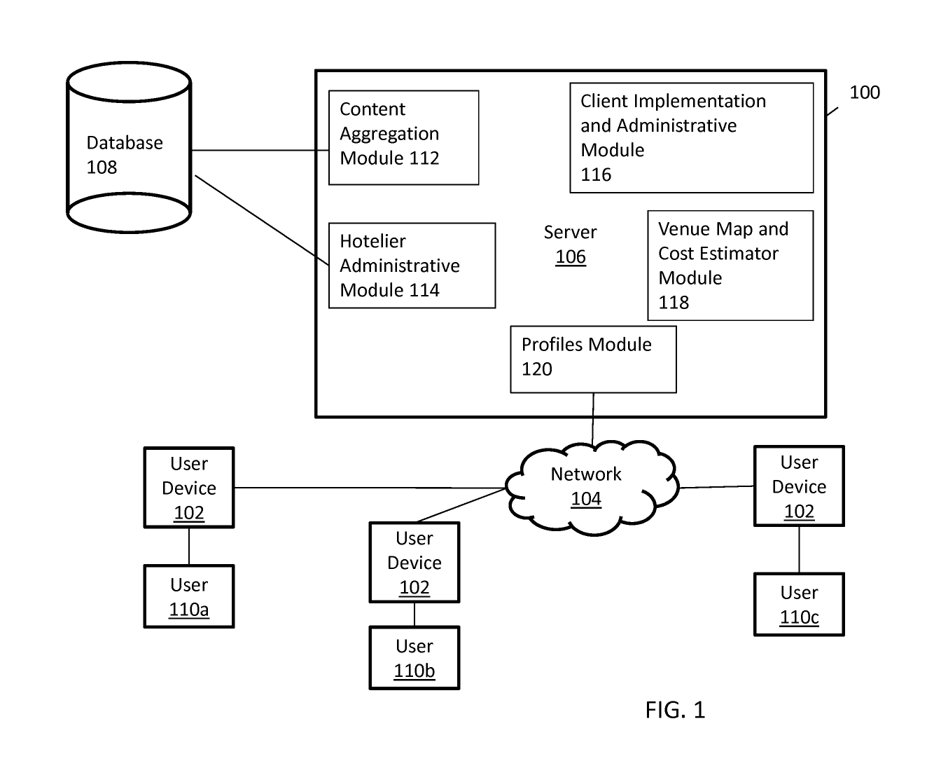

FIG. 1, generally at 100, shows a system diagram that includes the networked system according to some embodiments. Networked system 100 includes user devices 102, network 104, server 106, and database 108. Server 106 further includes Content Aggregation Module 112, Hotelier Administrative Module 114, Client Implementation and Administrative Module 116, Venue Map and Cost Estimator Module 118, and Profiles Module 120.

Preferably, system user devices 102 are in wireless communication with network 104. System user devices 102 can be any device capable of communicating with network 104. For example, system user devices 102 can be a laptop, desktop computer, tablet computer, personal computer, cell phone, including a personal digital assistant (PDA), a smartphone, user equipment, or other device permitting communication between a user and network 104.

As previously indicated, system user devices 102 may be user equipment. This user equipment may communicate with one or more radio access networks and/or with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system, such as Symbian OS, iPhone OS, RIM's Blackberry, Windows Mobile, Linux, HP WebOS, and Android. The screen may be a touch screen that is used to input data to the mobile device, in which case the screen can be used instead of the full keyboard.

One or more user device(s) 102 can include any computing device that is capable of performing computation and is also capable of providing location information. The location information to be obtained by the inclusion of a Global Positioning System (“GPS”) coordinate or a latitude/longitude coordinate. The user equipment discussed above can also keep global positioning coordinates, profile information, or other location information.

Each system user device 102 can send data to, and receive data from, server 106 via communication network 104. Each system user device 102 can be directly coupled to server 106; alternatively, each system user device 102 can be connected to server 106 via any other suitable device, communication network, or combination thereof. For example, each user device 102 can be coupled to server 106 via one or more routers, switches, access points, and/or communication networks (as described below in connection with communication network 104). Each system user device 102 can also include a processor and memory. The memory can be a non-transitory computer-readable medium, flash memory, a magnetic disk drive, an optical drive, a programmable read-only memory (PROM), a read-only memory (ROM), or any other memory or combination of memories. The software runs on the processor may be capable of executing computer instructions or computer code. The processor might also be implemented in hardware using an application specific integrated circuit (ASIC), programmable logic array (PLA), field programmable gate array (FPGA), or any other integrated circuit.

System user devices 102 are configured with one or more processors that process instructions and run software that can be stored in memory. The processor also communicates with the memory and interfaces to communicate with other devices. The processor can be any applicable processor such as a system-on-a-chip that combines a CPU, an application processor, and flash memory. User devices 102 also can provide a variety of user interfaces, such as a keyboard, a touch screen, a trackball, a touch pad, and/or a mouse. User devices 102 also can include speakers and a display device in some embodiments.

User devices 102 also include any platforms capable of computations and communication. Non-limiting examples can include televisions (TVs), video projectors, set-top boxes or set-top units, digital video recorders (DVR), computers, netbooks, laptops, and any other audio/visual equipment with computation capabilities.

System user devices 102 can be utilized by system users 110a-110c to interact with network 104. In some embodiments, system users 110a-110c can be a direct customer, an online travel agency (“OTA”), or a meetings management company (“MMC”). System user 110a can be a direct customer that can enter the system with a login, or a direct customer that utilizes the system without logging in. Direct customers without login credentials can be public users using a computer interface, such as a desktop or mobile interface. A direct customer with login credentials can be corporate and/or public users who register on the computer-based system to create a unique login for accessing the site through the computer interface.

System user 110b can be one of a plurality of OTAs that include corporate users and/or sourcing specialists and meeting planners who utilize the system on behalf of corporate clients.

System user 110c can be a MMC that sources specialists and meeting planners use for employing the system on behalf of corporate clients.

In some embodiments, system user 110a may include a direct customer who logs into the system. In some embodiments, a direct customer with login credentials can shop for venues based on real-time availability and compare availability and the prices of guest rooms, meeting space, F&B bundles, A/V bundles, and amenities, preferably, for up to 5 or more properties across different cities. In some embodiments, a direct customer with login credentials can save an itinerary to compare with a different itinerary at a later stage. A direct customer with login credentials can hold an itinerary to obtain approval, and upload credit card authorization details including scanned images or signed documents. As described herein, the term “hold” refers to registered users with login access holding bookings for a period pre-agreed with hotels while waiting to obtain approval.

In some embodiments, a direct customer with login credentials can book and contract for guest rooms, meeting space, F&B bundles, and A/V bundles, and pay for the booking using a card product or Automated Clearing House (“ACH”), Wire Transfer or PayPal. A direct customer with login credentials also can process changes, cancellations, and refunds online.

In some embodiments, system user 110b may be an OTA. In such embodiments, the system user can shop for venues based on real-time availability and compare availability, price of guest rooms, meeting space, F&B bundles, A/V bundles, and amenities. The OTA can hold an itinerary to obtain approval. The OTA can further share an availability report with the corporate meeting owner for approval, and conduct a two-step negotiation process with suppliers on a customer's behalf. The OTA also may book and contract, using a click-through contract, for guest rooms, meeting space, F&B bundles, and A/V bundles, or submit a payment request to the corporate meeting owner, or use payment information stored in the meeting owner's profile, or go through a payment approval process, such as using email with a link to make payments that go to the meeting owner who will either pay or authorize his/her OTA to make the payments using his/her card product. As used herein, the term “request” refers to meeting specifications that are submitted through a customized electronic form by the public, an OTA, or a MMC sourcing specialists and meeting planners.

In some embodiments, the OTA can process changes, cancellations, and refunds online, and send a summary package with budget and contract information to the corporate meeting owner. Further, the OTA can generate real-time meetings reporting by event or generate corporate level reporting on meeting demographics, spending, savings, etc., at the aggregate, business unit, and individual attendee levels. The OTA also can generate benchmark reporting based on like industry, like size, or like maturity of a Strategic Meetings Management (“SMM”) program.

In some embodiments, system user 110c includes a MMC that can shop for venues based on real-time availability. In some embodiments, the MMC can compare availability, price of guest rooms, meeting space, F&B bundles, A/V bundles, and amenities, or hold an itinerary to obtain approval. The MMC can share an availability report with the corporate meeting owner for approval, or, for example, can conduct a two-step negotiation process with suppliers on a customer's behalf. In some embodiments, the MMC can book and contract, using a click-through contract, for guest rooms, meeting space, F&B bundles, and A/V bundles, or can submit payment request to the corporate meeting owner, use payment information stored in the meeting owner's profile, or go through payment approval process, such as using email with a link to make payments go to the meeting owner who will either pay or authorize an OTA to make the payment using his/her card. Further, the MMC can process changes, cancellations, and refunds online, or can send a summary package with budget and contract information to the corporate meeting owner. In some embodiments, the MMC can generate real-time meetings reporting by event, or can generate corporate level reporting on meeting demographics, spending, savings, etc., at the aggregate, business unit, and individual attendee levels. The MMC also may generate benchmark reporting based on like an industry, like size, like maturity of a SMM program.

Network 104 may be a local area network (“LAN”), a wide area network (“WAN”), the Internet, a cellular network, a satellite network, or another network that permits communication between system user devices 102 and server 106. Network 104 can further include one, or any number, of the exemplary types of networks mentioned herein operating as a stand-alone network or in cooperation with each other. Network 104 can utilize one or more protocols of one or more clients or servers to which they are communicatively connected. Network 104 can translate to or from other protocols to one or more protocols of network devices. Although network 104 is depicted as one network, it would be appreciated by a person of ordinary skill in the art that in some embodiments, network 104 may include a plurality of interconnected networks. Other various network types or configurations also can be provided.

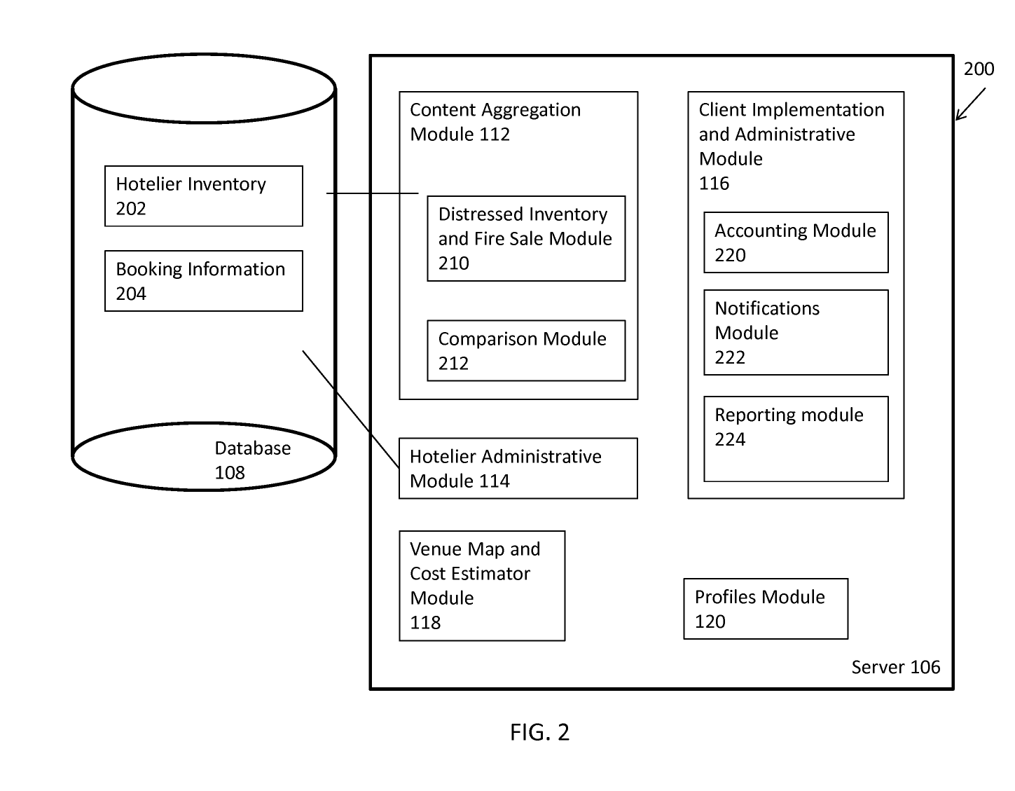

Server 106 can contain modules that implement the meeting distribution system as described more fully in FIG. 2 below. Server 106 contains a plurality of modules, including Content Aggregation Module 112, Hotelier Administrative Module 114, Client Implementation and Administrative Module 116, Venue Map and Cost Estimator Module 118, and Profiles Module 120. Each of these modules and their subcomponents are described more fully with reference to FIG. 2.

Server 106 can operate using any type of operating system (“OS”) software. In some embodiments, the OS software is based on a Linux software kernel and runs specific applications in the server, such as monitoring tasks and providing protocol stacks. The OS software can allow server resources to be allocated separately for control and data paths. For example, certain packet accelerator cards and packet services cards can be dedicated to performing routing or security control functions, while other packet accelerator cards/packet services cards can be dedicated to processing user session traffic. As network requirements change, hardware resources can be dynamically deployed to meet the requirements in some embodiments.

The server software can be divided into a series of tasks that perform specific functions. These tasks communicate with each other as needed to share control and data information throughout server 106. As stated herein, a “task” may be a software process that performs a specific function related to system control or session processing. Preferably, three types of tasks operate within server 106 in some embodiments: critical tasks, controller tasks, and manager tasks. The critical tasks control functions that relate to the server's ability to process calls, such as server initialization, error detection, and recovery tasks. The controller tasks can mask the distributed nature of the software from the system user and perform tasks, such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors can be divided into subsystems. For purposes of the present invention, a “subsystem” is a software element that either performs a specific task or is a culmination of multiple other tasks. A single subsystem can include critical tasks, controller tasks, and manager tasks. Some of the subsystems that run on server 106 include, but are not limited to, a system initiation task subsystem, high availability task subsystem, shared configuration task subsystem, and resource management subsystem.

The system initiation task subsystem may be responsible for starting a set of initial tasks at system startup and providing individual tasks as needed. The high availability task subsystem works in conjunction with the recovery control task subsystem to maintain the operational state of server 106 by monitoring the various software and hardware components of server 106. The recovery control task subsystem can be responsible for executing a recovery action for failures that occur in server 106 and receives recovery actions from the high availability task subsystem. Processing tasks can be separated into multiple instances running in parallel so that if an unrecoverable software fault occurs, the entire processing capabilities for that task are not lost. User session processes can be subgrouped into collections of sessions so that if a problem is encountered in one subgroup, users in another subgroup will not be affected by that problem.

The shared configuration task subsystem can provide server 106 with an ability to set, retrieve, and receive notification of server configuration parameter changes and is responsible for storing configuration data for the applications running within server 106. The resource management subsystem can be responsible for assigning resources (e.g., processor and memory capabilities) to tasks and for monitoring the task's use of the resources.

FIG. 2, generally at 200, shows an expanded view of the various modules 112, 114, 116, 118, and 120, and their subcomponents implemented within server 106 from FIG. 1. As shown in FIG. 2, server 106 contains Content Aggregation Module 112, Hotelier Administrative Module 114, Client Implementation and Administrative Module 116, Venue Map and Cost Estimator Module 118, and Profiles Module 120. Preferably, server 106 interfaces with database 108. Database 108 contains Hotelier Inventory 202 and Booking Information 204.

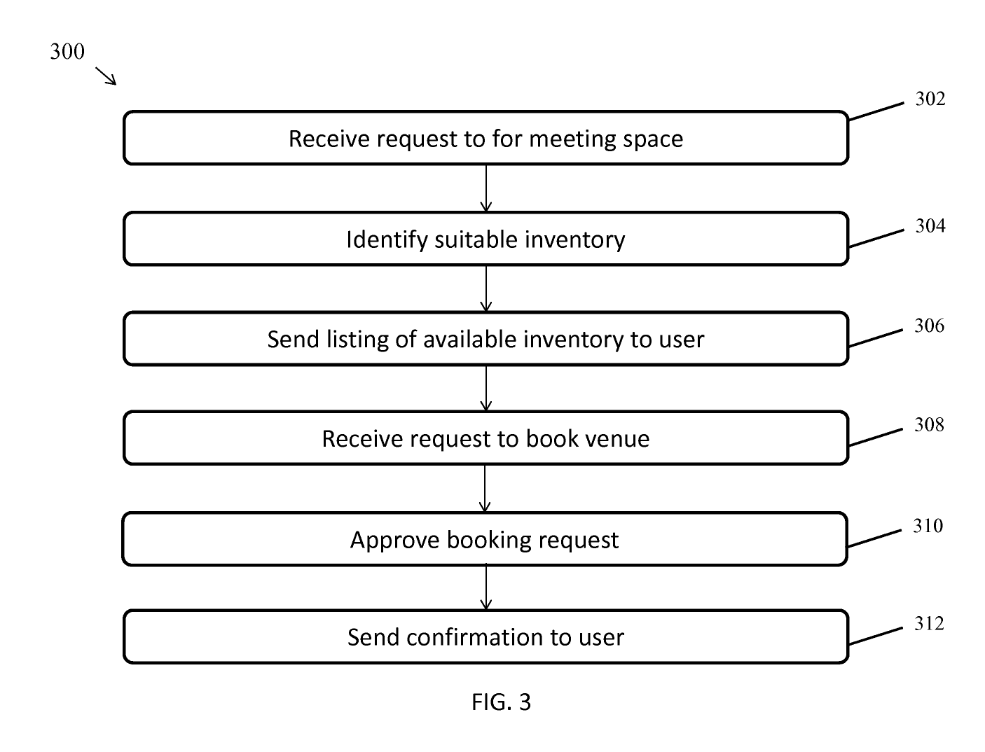

Content Aggregation Module 112 is a module within server 106 configured to acquire venue inventory and handle requests for inventory by system users. Content Aggregation Module 112 can contain Distressed Inventory and Fire Sale Module 210 and Comparison Module 212. Distressed Inventory and Fire Sale Module 210 can allow system users or venues to quickly generate contracts for distressed venues. Comparison Module 212 can allow system users to search and compare available venues prior to booking. Content Aggregation Module 112 can be configured to execute the computerized method described in FIG. 3.

Content Aggregation Module 112 can provide the core functionality of the meeting distribution system (“MDS”). Content Aggregation Module 112 can receive requests for availability, pricing, and amenities from system users, e.g., system users 110a-110c. In one embodiment, system users 110a-110c can shop for available venues based on real-time availability. When a system user shops for available venues, the system can identify available venues in real time, together with guest rooms meeting space, and F&B and A/V bundle pricing.

In some embodiments, Content Aggregation Module 112 can permit system users 110a-110c to view marketing and promotions from registered suppliers, and compare availability and prices of guest rooms, meeting spaces, F&B bundles, A/V bundles, and amenities for a threshold number of properties for any given city. As used herein, the term “compare” refers to the system presenting, in real-time, available venues, together with guest room, meeting space, and F&B and A/V bundle pricing. In some embodiments, system users 110a-110c can access Content Aggregation Module 112 to book and contract for guest rooms, meeting space, F&B bundles, and A/V bundles. Further, Content Aggregation Module 112 can permit system users 110a-110c to pay for a booking using a card product, e.g., credit, debit or prepaid card, and process changes, cancellations, and refunds online.

Content Aggregation Module 112 also can aggregate content from inventory management systems. Inventory management systems are systems that store inventory information from venues. This information will be collected and stored in database 108 as Hotelier Inventory 202. Hotelier Inventory 202 contains all data associated with individual guest rooms, meeting spaces, catering, F&B inventory, and A/V inventory systems at the property level for venues that make use of the system.

In some embodiments, Content Aggregation Module 112 can source corporate-negotiated rates from database 108 for customers with negotiated rates for guest rooms, meeting space, F&B and A/V bundles. In other embodiments, Content Aggregation Module 112 can push availability, pricing, and amenity information to a comparative matrix, which (1) in the public view is shared directly with end users and (2) in the corporate views is pushed to the OTA or MMC to share with the meeting owner.

In some embodiments, Content Aggregation Module 112 can save transactional data in database 108 as it is generated by system users for reporting, benchmarking, regulatory, and safety and security purposes. The saved transactional data can include, for example, spend and save data, spend per attendee, historical rate information, and attendee information including mobile device phone numbers.

Distressed Inventory and Fire Sale Module 210 within Content Aggregation Module 112 can connect to Hotelier Administration Module 114 and allow customers with contracted venues to sell their contracts to other customers, if necessary. In some embodiments, this module permits listing of venues at discounted prices. Distressed Inventory and Fire Sale Module 210 also can allow for the completion of a sale by facilitating payments between seller and buyer. In other embodiments, Distressed Inventory and Fire Sale Module 210 can allow hoteliers to move unsold inventory by, for example, listing venues for discounted prices.

Comparison Module 212 within Content Aggregation Module 112 can allow system users to search and compare available venues prior to booking. In some embodiments, the search criteria may include a city, dates of stay, date of meeting, number of guest rooms, and number of meeting attendees.

In one example, unregistered system user 110a can compare up to 5 or more properties per city. In this embodiment, registered system user 110a can compare up to 3 or more properties and up to 5 or more cities. In addition, registered system user 110a can save an itinerary for comparison with other itineraries at a later time. Other examples are within the scope of the present invention.

Hotelier Administrative Module 114 is a module within server 106 configured to perform administrative tasks. Hotelier Administrative Module 114 can be configured to connect to Content Aggregation Module 112 and content database 108. Hotelier Administrative Module 114 can upload event-by-event negotiated rates resulting from the MDS negotiations process to database 108 for later use by Content Aggregation Module 112.

Client Implementation and Administrative Module 116 is a module within server 106 configured to act as a security module within server 106. Client Implementation and Administrative Module 116 contains Accounting Module 220, Notifications Module 222, and Reporting Module 224. Accounting Module 220 maintains transaction level financial information for the MDS system. Notifications Module 222 is an email engine that enables OTA and MMC sourcing specialists to send and receive emails through the MDS system. Reporting Module 224 provides reporting on the database 108.

Client Implementation and Administrative Module 116 is an administration module that oversees access to, and security for, the MDS system for all end-user types, and allows for custom configuration of some aspects of the system operation, in addition to facilitating uploading of suppliers or customer-unique data. Client Implementation and Administrative Module 116 also interfaces with, and grants access to, Profiles Module 120, Content Aggregation Module 112, Hotelier Administration Module 114, and Distressed Inventory and Fire Sale Administration Module 210. In controlling access, Client Implementation and Administrative Module 116 supports password management, self-enrollment of users, uploading of preferred suppliers and negotiated rates, and uploading of corporate hierarchy and HR data feeds. The MDS system also can allow for context sensitive supplier promotions for system users 110a-110c who do not login to the system, and the preferencing of supplier promotions based on tiered pricing.

Accounting Module 220 can maintain transaction level financial information and store the information in database 108. The transaction level financial information can include, for example, fees associated with venue bookings by the public, and OTA and MMC staff. In addition, Accounting Module 220 can calculate commissions from hotels based on agreed upon contracts, and calculate transaction fees from customers, including direct customers, OTAs, and MMCs.

Notifications Module 220 can provide send-and-receive email capability to OTA and MMC, and system users. Notifications module 220 allows system users to share availability reporting with the corporate meeting owner for approval. In one example, Notification Module 220 permits system users to finalize an itinerary and submit the itinerary to the corporate meeting owner for approval. Further, Notification Module 220 can submit payment requests to the corporate meeting owner and have the meeting owner submit payment information, and can send a summary package with budget and contract information to the corporate meeting owner.

Reporting Module 224 provides detailed reporting information for content stored within database 108. In particular, this module can provide reporting on meeting demographics, spending, savings, etc., at the aggregate, business unit, and individual attendee levels. In addition, the module can provide benchmarks on Program Benchmarks, Sourcing Metrics, Main Meeting Types, Chain Behavior, Destination Behavior, and Meeting Size Behavior, as well as create “What if” reporting to determine rates at historical snapshots.

Reporting Module 224 can interface with database 108, which stores information related to inventory (e.g., Hotelier Inventory 202), and information related to bookings (e.g., Booking Information 204). Booking Information 204 may include, for example, information related to individual matched users and venues. In addition to this information, Booking Information 204 can be used by Reporting Module 224 to generate generalized reports that may include overall meeting demographics, amounts spent by system users, savings from the market rate, and individual attendee levels. Database 108 also can be used by Reporting Module 224 to generate benchmarking information. The benchmarking information can include, but not be limited to, Room Night Behavior, such as Average Group Rate (“AGR”), Average Room Nights per Program, Meeting Mix Overview; Sourcing Metrics, such as Average Properties Sourced, Times Sourced, Average Lead Days; and Main Meeting Types, such as By Meeting Type: AGR, Average Room Nights per Program. Database 108 can also store chain behavior, including, for example, Main Chains, such as AGR Overview: AGR by Chain. Further, Database 108 can store Destination Behavior, such as Top Destinations: AGR, Room Nights Percentage. Still further, Database 108 can store Meeting Size Behavior By Meeting Size Compared to Peers, and Historical Snapshots, including Event level negotiated pricing information and rate information.

Venue Map and Cost Estimator Module 118 is a module within server 106 that is preferably configured to allow system users to possible venues on a Google map. Although a Google map is mentioned, other map systems are considered within the scope of the invention. Venue Map and Cost Estimator Module 118 can provide detailed location information including geographic areas, as well as specific locations of client office sites. In addition, this module can allow system users, such as system users 110a-110c, to estimate the cost of an event within certain parameters.

Profiles module 120 is a module within server 106 that preferably facilitates the booking process by collecting data associated with system user devices 102a-102c. Once the data is collected and stored in database 108, Profile Module 120 can store meeting owner profile information, which eliminates the need to reenter this information for each meeting request into the MDS system. In addition, this feature allows profiles to be created for Executive Assistants and other people in an organization who book meetings on behalf of others to setup their profiles and add the meeting owner's information for the approval workflow.

Profiles module 120 can collect substantial data from system users to assist in the venue matching process. An exemplary list of data that may be collected includes:
1. Event Profile Data, such as Event Name, Event Owner Name, Event Owner Home Company, Event Owner Home Business Unit, Event Owner Contact Email, Event Owner Contact Phone, Event Sourcer, Event Planner, Event Start Date, Event End Date, Event Venue Name, Event Address 1, Event Address 2, Event City, Event State, Event Postal Code, Event Country, and Event Venue Class of Service.
2. Attendee Data, such as Attendee Name, Attendee Title, Attendee Company,

Attendee Business Unit, Attendee Phone Number, Attendee Mobile Number, Attendee Emergency Contact Name, Attendee Emergency Contact Phone Number, Attendee Flight Data, Airline 1, Airline 2, Flight Date Segment 1, Flight Date Segment 2, Flight Date Segment 3, Flight Date Segment 4, Flight Date Segment 5, Flight Date Segment 6, Flight Segment 1, Flight Segment 2, Flight Segment 3, Flight Segment 4, Flight Segment 5, and Flight Segment 6.
3. Venue Transactional Data such as Venue Name, Venue Booking Transaction Date, Venue Total Transaction Amount, Venue Cancellation Fees, Venue Attrition Fees, Venue Room Fees, Standard Room (individual and aggregate), VIP Room (individual and aggregate), and Staff Room (individual and aggregate).
4. Venue Meeting Space Fees.
5. Venue Food and Beverage Fees such as Breakfast (individual and aggregate), Morning Break (individual and aggregate), Lunch (individual and aggregate), Afternoon Break (individual and aggregate), Cocktails (individual and aggregate), Dinner (individual and aggregate).
6. Venue Audio Visual Fees such as Projectors, Cables, Power Strips, Microphones, Amplifiers, and Mixers.
7. Service Fee Data such as Meeting Distribution System Fees, Direct Customer Fees, Mobile Customer Fees, OTA Fees, and MMC Fees.

FIG. 3, generally at 300, shows a computerized method for matching system users and venues in accordance with the MDS of the present invention. Preferably, method 300 includes steps 302, 304, 306, 308, 310, and 312. At step 302, a new request for meeting space is received by the MDS from a system user. At step 304, suitable venue inventory is identified and acquired. At step 306, a listing of available inventory is provided to requesting system user. At step 308, a request to book an available venue is received by the MDS. At step 310, the booking request is approved and logged by the MDS. At step 312, confirmation is sent to the system user and the method ends.

As stated, at step 302, a new request for meeting space is received by the MDS from a system user. More specifically, a system user, such as, system user 110a, 110b, or 110c, associated with a system user device 102 sends a request to locate meeting space via network 104 to server 106. The system user may connect to the MDS system via a desktop or mobile user interface. System user device 102 can be any mobile or desktop device capable of interfacing with MDS 100. The request may include information regarding the system user's needs for the booking including, for example, date and time, pricing, location, and space information.

Again as stated previously, at step 304, venue inventory information can be acquired. Venue inventory information is the set of all inventories available on system 106. In one embodiment, venue inventory information is stored at Hotelier Information 202 of database 108. At this step, the MDS will review all available venues for those venues that meet the needs provided by system user at step 302.

As previously stated, at step 306, available venues are sent to the system user, such as system users 110a-110c. At this step, all venues that matched the system user's preferences are compiled and provided to the system user to allow the system user to select a match.

As stated, at step 308, the system user can send a notification of a selected venue. In some embodiments, the system user can select a first choice, second choice, and third choice venue in case of a change in availability.

As stated previously, at step 310, the MDS can approve the booking request. At this step, the system user's payment information is processed and the venue is marked in database 108 as no longer available for the selected time.

Again as previously stated, at step 312, a notification indicating a successful booking is sent to the system user, which ends the process.

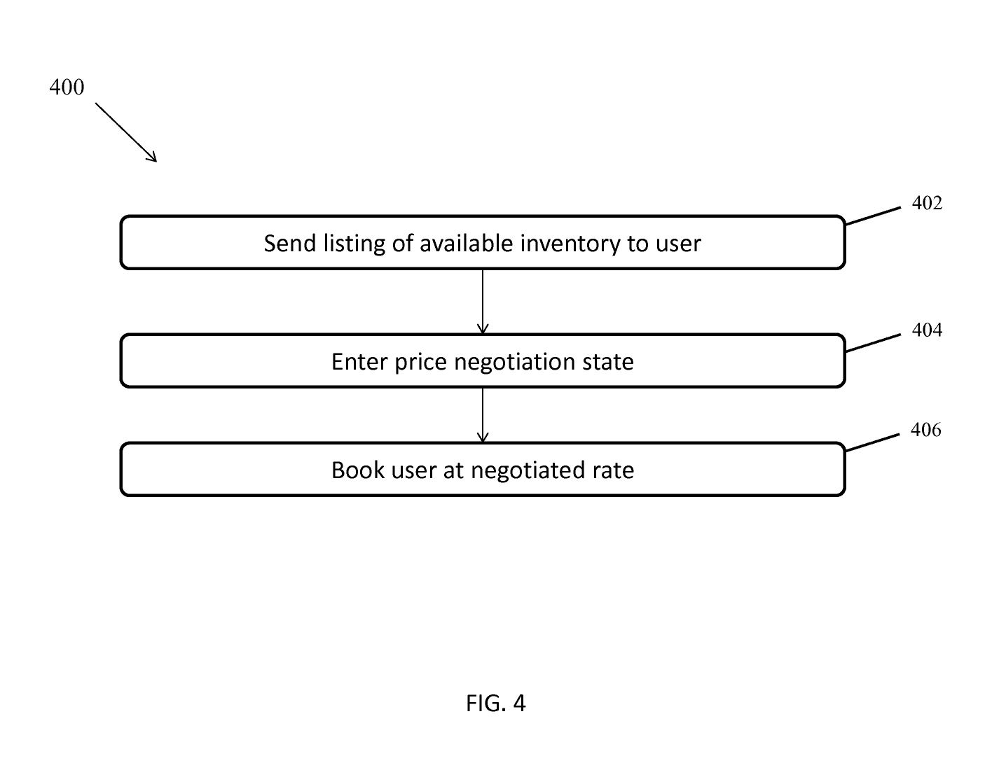

FIG. 4, generally at 400, shows a computerized method for negotiating prices for venues in accordance with the MDS of the present invention. Preferably, method 400 includes steps 402, 404, and 406. At step 402, a listing of available inventory is provided to a requesting system user. At step 404, the user and system enter the price negotiation state. At step 406, the booking request is approved at the negotiated rate and logged by the MDS. Steps 402-406 may be executed as an alternative to, or integrated with, steps 306 and 308 in FIG. 3.

As stated, at step 402, available venues are sent to the system user. Preferably, available venues for this method will only be provided to system users that include an OTA or a MMC, such as system users 110b-110c. At this step, all venues that matched the system user's preferences are compiled and provided to the system user to allow the system user to select a match.

As stated, at step 404, the price negotiation state is entered. The price negotiation can be executed at Client Implementation and Administrative Module 116. In this state, the MDS will open communication with the system user to negotiate a mutually agreeable price for a matched venue. In one example, the system can store a list price in Hotelier Inventory 202, and a lowest price for a sale that is less than the list price. The system user can offer a price for one or more venues and attempt to find a suitable venue at a desired price. In one embodiment, the user can submit a highest price that the user will pay for a list of venues, and the MDS can automatically select a matching venue based on the submitted list including the amounts the system user is willing to pay.

As stated previously, at step 406, the MDS can approve and log the booking request. At this step, the system user's negotiated price for the venue is approved based on Hotelier Inventory information 202 stored in database 108. At this step, payment information is processed and the venue is marked in database 108 as no longer available for the selected time.

The embodiments or portions thereof of the system and method of the present invention may be implemented in computer hardware, firmware, and/or computer programs executing on programmable computers or servers that each includes a processor and a storage medium readable by the processor (including volatile and non-volatile memory and/or storage elements). Any computer program may be implemented in a high-level procedural or object-oriented programming language to communicate within and outside of computer-based systems.

Any computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the embodiments. The embodiments or portions thereof may also be implemented as a machine-readable storage medium, configured with a computer program, where, upon execution, instructions in the computer program cause a machine to operate to perform the functions of the embodiments described above.

The embodiments or portions thereof of the system and method of the present invention described above may be used in a variety of applications. Although the embodiments or portions thereof are not limited in this respect, the embodiments or portions thereof may be implemented with memory devices in microcontrollers, general purpose microprocessors, digital signal processors (DSPs), reduced instruction-set computing (RISC), and complex instruction-set computing (CISC), among other electronic components. Moreover, the embodiments, or portions thereof, described above may also be implemented using integrated circuit blocks referred to as main memory, cache memory, or other types of memory that store electronic instructions to be executed by a microprocessor or store data that may be used in arithmetic operations.

The descriptions are applicable in any computing or processing environment. The embodiments, or portions thereof, may be implemented in hardware, software, or a combination of the two. For example, the embodiments, or portions thereof, may be implemented using circuitry, such as one or more of programmable logic (e.g., an ASIC), logic gates, a processor, and a memory.

The terms and expressions that are employed herein are terms or descriptions and not of limitation. There is no intention in the use of such terms and expressions of excluding the equivalents of the feature shown or described, or portions thereof, it being recognized that various modifications are possible within the scope of the invention as claimed.

1. A computer-based method for managing a selection of venues and services, comprising the steps of:
(A) a user inputting to a user input device user requirements for at least a venue and associated services;
(B) receiving at a profile collection component of a system server electronically connected to the user input device a profile from user input device that includes at least the venue and associated services requirements;
(C) an administrative component of the system server connected to the profile collection component comparing the user profile received from the profile collection component with supplier inventory stored in a database electrically connected to administration component;
(D) the system server generating a list of venues and associated services that match one or more requirements of the profile received from the electronic profile collection component;
(E) the system server transmitting to the user input device via the profile collection component a listing of the venues and associated services that match one or more requirements of the user based on the comparison at step (C);
(F) the user selecting on the user input device one or more venues and associated services transmitted to the user input device at step (E);
(G) the user input device transmitting to the system server the selection of one or more venues and associated services selected at step (F); and
(H) the system server at least blocking out from the database the one or more venues and associated services transmitted to the system server at step (G) and preventing selection of same by another user until such time as the one or more venues and associated services are released.

2. The method of claim 1, further comprising: the system server
approving the chosen venue and associated services and
generating a booking for the user and at least one supplier of the venue and associated services.

3. The method of claim 2, further comprising:
notifying the user input device and computer-based supplier device of the completed booking.

4. The method of claim 1, wherein the user includes at least one of a direct user, an online travel agency (OTA), or a meetings management company (MMC).

5. The method of claim 1, wherein the system server generating the list including the listing of venues and associated services includes determining that each venue and associated service of the collection matches at least one condition provided by the user.

6. The method of claim 5, wherein the at least one condition includes at least one of a geographic area and a total cost.

7. The method of claim 3, further comprising:
the system server receiving a request from the user input device to modify the completed booking and
the system server processing the request by updating the booking for the user.

8. A non-transitory computer-readable storage medium having stored thereon, computer-executable instructions that, if executed by a computer system cause the computer system to perform a method of managing venues and associated services, the method comprising the steps of:
(A) a user inputting to a user input device user requirements for at least a venue and associated services;
(B) receiving at a profile collection component of a system server electronically connected to the user input device a profile from user input device that includes at least the venue and associated services requirements;
(C) an administrative component of the system server connected to the profile collection component comparing the user profile received from the profile collection component with supplier inventory stored in a database electrically connected to administration component;
(D) the system server generating a list of venues and associated services that match one or more requirements of the profile received from the electronic profile collection component;
(E) the system server transmitting to the user input device via the profile collection component a listing of the venues and associated services that match one or more requirements of the user based on the comparison at step (C);
(F) the user selecting on the user input device one or more venues and associated services transmitted to the user input device at step (E);
(G) the user input device transmitting to the system server the selection of one or more venues and associated services selected at step (F); and
(H) the system server at least blocking out from the database the one or more venues and associated services transmitted to the system server at step (G) and preventing selection of same by another user until such time as the one or more venues and associated services are released.

9. The non-transitory computer-readable storage medium of claim 8, wherein the method further comprises: the system server
approving the chosen venue and associated services and
generating a booking for the user and at least one supplier of the venue and associated services.

10. The non-transitory computer-readable storage medium of claim 9, wherein the method further comprises:
notifying the user input device and computer-based supplier device of the completed booking.

11. The non-transitory computer-readable storage medium of claim 8, wherein the user includes at least one of a direct user, an online travel agency (OTA), or a meetings management company (MMC).

12. The non-transitory computer-readable storage medium of claim 8, wherein the system server generating the list including the listing of venues and associated services includes determining that each venue and associated service of the collection matches at least one condition provided by the user.

13. The non-transitory computer-readable storage medium of claim 12, wherein the at least one condition includes at least one of a geographic area and a total cost.

14. The non-transitory computer-readable storage medium of claim 10, wherein the method further comprises:
the system server receiving a request from the user input device to modify the completed booking and
the system server processing the request by updating the booking for the user.

15. A system server comprising:
a hardware processor; and
memory coupled to the processor, with the memory includes instructions that when executed cause system server to perform a method of managing venues and associated services, with the method including at least the steps of:
(A) a user inputting to a user input device user requirements for at least a venue and associated services;
(B) receiving at a profile collection component of a system server electronically connected to the user input device a profile from user input device that includes at least the venue and associated services requirements;
(C) an administrative component of the system server connected to the profile collection component comparing the user profile received from the profile collection component with supplier inventory stored in a database electrically connected to administration component;
(D) the system server generating a list of venues and associated services that match one or more requirements of the profile received from the electronic profile collection component;
(E) the system server transmitting to the user input device via the profile collection component a listing of the venues and associated services that match one or more requirements of the user based on the comparison at step (C);
(F) the user selecting on the user input device one or more venues and associated services transmitted to the user input device at step (E);
(G) the user input device transmitting to the system server the selection of one or more venues and associated services selected at step (F); and
(H) the system server at least blocking out from the database the one or more venues and associated services transmitted to the system server at step (G) and preventing selection of same by another user until such time as the one or more venues and associated services are released.

16. The system server of claim 15, wherein the method further comprises: the system server
approving the chosen venue and associated services and
generating a booking for the user and at least one supplier of the venue and associated services.

17. The system server of claim 16, wherein the method further comprises:
notifying the user input device and computer-based supplier device of the completed booking.

18. The system server of claim 15, wherein the user includes at least one of a direct user, an online travel agency (OTA), or a meetings management company (MMC).

19. The system server of claim 15, wherein the system server generating the list including the listing of venues and associated services includes determining that each venue and associated service of the collection matches at least one condition provided by the user.

20. The system of claim 19, wherein the at least one condition includes at least one of a geographic area and a total cost.
